(19) United States
(12) Patent Application Publication
(10) Pub. No.: US 2004/0113901 A1
(43) Pub. Date: Jun. 17, 2004

(54) Signal processor

(76) Inventor: Isao Kawahara, Toyono-gun (JP)

Correspondence Address: SNELL & WILMER LLP, 1920 MAIN STREET, SUITE 1200, IRVINE, CA, 92614-7230, US

(21) Appl. No.: 10/466,506

(22) PCT Filed: Jan. 24, 2002
(86) PCT No.: PCT/JP02/00488

(30) Foreign Application Priority Data
Jan. 26, 2001 (JP) 2001-18152

(51) Int. Cl. G09G 5/00

(52) U.S. Cl. 345/204

(57) ABSTRACT

Erroneous writing may occur to write scanning of images using subfields, depending on patterns and motions of the images. A pattern for which erroneous writing is liable to occur is subjected to a different correction process depending on whether the pattern is a still image or a moving image. For a moving image part, in particular, pixels at the top edge of the image are activated by preceding writing of a low luminance, so as to ensure a correct writing operation.

### TECHNICAL FIELD

The present invention relates to such a display apparatus as a plasma display panel (PDP) in which display information is written into each pixel positioned on the same line, i.e., the writing operation is realized by line-by-line scan, so as to write display information into all pixels. In particular, the present invention relates to a signal processing device for use in a display apparatus that performs display by a stable operation of writing display information.

### BACKGROUND ART

For gray-scale display using such display apparatuses as PDPs, the “intra-field time division gray-scale display method” is typically employed. With this method, gray-scale display can be realized by first dividing an image corresponding to one field into a plurality of subfields and assigning a predetermined weight of luminance to each subfield, and then controlling whether or not to light each subfield. To display an image in 256 levels of gray-scale, for example, an input signal corresponding to one field is first divided into eight pieces of display information respectively corresponding to eight subfields. Assume here that luminance weights to be assigned are 1, 2, 4, 8, 16, 32, 64, and 128, and that the input signal is an eight-bit input digital signal with the eight bits respectively corresponding to the eight subfields. In this case, the luminance weights of 1, 2, 4, 8, 16, 32, 64, and 128 are respectively assigned, from the lowest-order bit of the eight bits, to the eight subfields. For each bit, light emission of the corresponding subfield is controlled, so as to control a gray-scale level of each pixel of the image to be displayed. Here, such display apparatuses as PDPs, in which a wall charge is formed by way of discharge so as to write pieces of display information into pixels, may have the following problem. Depending on their characteristics, some PDPs may suffer from the problem that display information correctly matching an image signal to be displayed cannot be written.

To solve this problem, Japanese Laid-Open Patent Application No. H10-133624 discloses one technique to avoid displaying gray-scale levels with a high probability of erroneous writing of display information on the present line. According to this conventional technique, display information of the present line is corrected using display information of the preceding line, and also, lighting a plurality of subfields at once, rather than lighting a single subfield, is often carried out.

With this conventional technique for correction, however, the problem of erroneous writing cannot be completely solved. In some cases, such correction may be insufficient. In other cases, certain image patterns have no room for such correction. The following gives one example of the case where the probability of erroneous writing is high and the visual influence caused by the erroneous writing is serious. This case is where the preceding line is “0”, i.e., the intended luminance of the preceding line is “0”, and the intended luminance of the present line is the maximum value, i.e., the pattern to be displayed on the present line has such luminance that requires all the subfields to emit light. In this case, conventional techniques fail to correct erroneous writing. Further, for a still image and a moving image with the same pattern but with a different probability of erroneous writing, conventional techniques fail to provide correction processes separately suitable for a still image and for a moving image.

### DISCLOSURE OF THE INVENTION

In view of the above problems, the first object of the present invention is to provide correction processes of sufficiently correcting erroneous writing for various image patterns.

Also, the second object of the present invention is to realize a correction process suitable for a still image and a correction process suitable for a moving image, so as to enable favorable writing of display information.

The first object of the present invention can be achieved by a signal processing device that enables a display apparatus to perform image display using a plurality of subfields into which one field is divided, by writing display information of one subfield into pixels on each scan line of the display apparatus based upon an image signal of one field, the signal processing device characterized by including a correction unit operable to correct an image signal corresponding to display information to be written into a j-th pixel on at least one scan line preceding, in terms of a writing order, an i-th scan line within one field, based upon a pattern of display information to be written into a j-th pixel on the i-th scan line and a pattern of display information to be written into a j-th pixel on a scan line preceding the i-th scan line.

In this way, the present invention uses a technique for “correcting an image signal corresponding to display information to be written into a j-th pixel on at least one scan line preceding, in terms of a writing order, the i-th scan line within one field”, “based upon a pattern of display information to be written into a j-th pixel on the i-th scan line and a pattern of display information to be written into a j-th pixel on a scan line preceding the i-th scan line”, instead of using the conventional technique for correcting display information of the present line using display information of the preceding line, or for often carrying out lighting a plurality of subfields at once, rather than lighting a single subfield. Therefore, for example, even when the preceding line is “0”, i.e., the intended luminance of the preceding line is “0”, and the intended luminance of the present line is the maximum value, i.e., the pattern to be displayed on the present line has such luminance that requires all the subfields to emit light, the probability of erroneous writing can be kept low. According to the present invention, therefore, the j-th pixel to be displayed on the i-th scan line, i.e., a line for which writing is to be performed, can be activated regardless of an image pattern. Due to this, erroneous writing becomes less liable to occur. This effect can be clearly seen in the embodiments of the present invention described later.

This effect produced by correction for reducing the erroneous writing is particularly remarkable when the present invention is applied to a display panel that is made up of a front plate and a back plate placed as opposed to each other with barrier ribs interposed between them, where pixels on the same scan line are separated from one another by the barrier ribs, and pixels on the same vertical line are spatially connected with one another.

The second object of the present invention can be achieved by a signal processing device that enables a display apparatus to perform image display using a plurality of subfields into which one field is divided, by writing display information of one subfield into pixels on each scan line of the display apparatus based upon an image signal of one field, the signal processing device characterized by including a correction unit operable to correct an image signal corresponding to display information to be written into a j-th pixel on at least one scan line preceding, in terms of a writing order, an i-th scan line within one field, based upon a pattern of display information to be written into a j-th pixel on an i-th scan line over a plurality of fields.

In this way, the present invention uses a technique for “correcting an image signal corresponding to display information to be written into a j-th pixel on at least one scan line preceding, in terms of a writing order, an i-th scan line within one field”, “based upon a pattern of display information to be written into a j-th pixel on the i-th scan line over a plurality of fields”, instead of using the conventional technique for correcting display information of the present line using display information of the preceding line, or for often carrying out lighting a plurality of subfields at once, rather than lighting a single subfield. Therefore, even for a still image and a moving image with the same pattern but with a different probability of erroneous writing, suitable correction processes can be provided. This effect can be clearly seen in the embodiments of the present invention described later. Here, the range of correction to be performed on an image can be made varied depending on whether the image is a moving image or a still image. By doing so, an erroneous operation can be effectively reduced particularly for a moving image for which an erroneous writing operation, if occurs, is highly visible.

This effect produced by correction for reducing the erroneous writing is particularly remarkable when the present invention is applied to a display panel that is made up of a front plate and a back plate placed as opposed to each other with barrier ribs interposed between them, where pixels on the same scan line are separated from one another by the barrier ribs, and pixels on the same vertical line are spatially connected with one another.

Here, the signal processing device is characterized in that the display information is information for lighting each pixel, and the correction unit is operable to correct the image signal so as to increase a frequency of writing display information into the j-th display pixel on at least one scan line preceding, in terms of a writing order, the i-th scan line.

When a method for selectively generating write discharge only in pixels to be displayed so as to accumulate a wall charge therein is employed as a method for writing display information into each pixel, activation of the present line is facilitated by, according to the present invention, increasing the frequency of writing on the line preceding, in terms of a writing order, the present line, thereby reducing erroneous writing on the present line. Here, space charges (priming particles) generated due to the writing exist over a plurality of subfields. Therefore, when the frequency of writing is controlled to be increased on the preceding line, the frequency of writing may not necessarily be increased within the same field, but may be increased over different subfields. In this case, too, the accuracy of writing information can be enhanced by increasing the degree of activation of pixels.

Here, the signal processing device is characterized in that the display information is information for erasing each pixel, and the correction unit is operable to correct the image signal so as to increase a frequency of writing display information into the j-th display pixel on at least one scan line preceding, in terms of a writing order, the i-th scan line.

When a method for accumulating in advance a wall charge in all pixels, and selectively causing weak discharge in pixels not to be displayed, so as to eliminate a wall charge therein while maintaining a wall charge in pixels to be displayed is employed as a method for writing display information into each pixel, activation of the present line is facilitated by, according to the present invention, increasing the frequency of erasing on the line preceding, in terms of a writing order, the present line, thereby reducing erroneous writing (here, erroneous erasing) on the present line. Here, space charges (priming particles) generated due to the erasing exist over a plurality of subfields. Therefore, when the frequency of writing is controlled to be increased on the preceding line, the frequency of erasing may not necessarily be increased within the same field, but may be increased over different subfields. In this case, too, the accuracy of writing information can be enhanced by increasing the degree of activation of pixels.

Here, the signal processing device is characterized in that the correction unit is operable to correct the image signal so as to increase a frequency of writing display information into a pixel (a) by a smaller degree as a scan line of the pixel precedes more, in terms of a writing order, the i-th scan line, or (b) by a substantially same degree as a scan line preceding, in terms of a writing order, the i-th scan line.

Here, the signal processing device is characterized in that the correction unit is operable to correct the image signal so as to increase a frequency of writing display information into a pixel (a) by a smaller degree as a scan line of the pixel precedes more, in terms of a writing order, the i-th scan line, or (b) by a substantially same degree as a scan line preceding, in terms of a writing order, the i-th scan line.

The following methods are typically well known as the method for writing display information into each pixel. One method is for selectively generating write discharge only in pixels to be displayed, so as to accumulate a wall charge therein. Another method is for accumulating in advance a wall charge in all pixels, and selectively causing weak discharge in pixels not to be displayed, so as to eliminate a wall charge therein while maintaining a wall charge in pixels to be displayed.

The present invention provides a specific technique for correcting information to be written into the j-th display pixel when the above writing methods are employed. With such a specific technique provided by the present invention, a difference between the image produced as a result of correction and the original image can be minimized, thereby reducing the visual influence.

Here, it is preferable that the correction unit corrects the image signal when an image to be displayed for the j-th pixel on the i-th scan line corresponds to an edge part of a moving image.

Erroneous writing is particularly liable to occur in an edge part of a moving image because an image pattern often changes greatly in the edge part. Such a correction process focusing on the edge part of a moving image can reduce erroneous writing occurring in the edge part.

Here, it is preferable that the edge part of the moving image is a part moving in a direction inverse to a direction in which writing of display information is performed in each subfield.

In particular, erroneous writing is liable to occur to a moving image that moves in the direction inverse to the direction in which display information is written in each subfield. This is because an image moves into an area that is insufficiently activated. Accordingly, such a correction process as provided by the present invention, namely, the correction process focusing on an edge part of a moving image moving in the direction inverse to the direction where display information is written in each subfield, can reduce erroneous writing occurring in a part of a moving image moving in the direction inverse to the direction in which display information is written in each subfield.

Here, it is preferable that the signal processing device is characterized in that the correction unit is operable to correct the image signal in such a manner that an amount of light emission on a line preceding, in terms of a correction order, the i-th scan line is half or less of an amount of light emission on the i-th scan line.

In the case where an image signal corresponding to display information to be written into the j-th pixel is corrected, a problem may occur such that the edge of an image becomes vague or the visual influence becomes serious when an amount of light emission of a pixel after correction is too large. Therefore, it is preferable to take this problem into consideration in correcting information to be written into the j-th pixel to be displayed. According to the present invention, this problem is handled by limiting the correction amount of light emission on the line preceding the i-th scan line to half or less of the amount of light emission on the i-th scan line.

Here, the signal processing device is characterized in that the correction unit is operable to increase a frequency of writing display information in a subfield selected from a plurality of subfields, according to priority of a smaller luminance assigned thereto.

In the case where an image signal corresponding to display information to be written into the j-th pixel is corrected, a problem may occur such that the edge of an image becomes vague or the visual influence becomes serious when an amount of light emission of a pixel after correction is too large. Therefore, it is preferable to take this problem into consideration in correcting information to be written into the j-th pixel to be displayed. According to the present invention, this problem is handled by increasing the frequency of writing in a subfield selected, out of a plurality of subfields, according to priority of a smaller luminance weight assigned thereto.

Here, it is preferable that the signal processing device is characterized in that the correction unit is operable to perform a broader range of correction in a part where an image to be displayed therein has a large variety of luminance, than in a part where an image to be displayed therein has a small variety of luminance.

Due to this, a suitable correction process can be performed on the preceding line according to the in-plane luminance of an image.

Here, the signal processing device is characterized in that the correction unit includes: a line memory for storing image signals corresponding to a plurality of lines; a pattern detecting subunit operable to detect a predetermined image pattern that has an influence on writing, by reading the image signals corresponding to the plurality of lines from the line memory and comparing the image signals; and a conversion subunit operable to correct a pixel signal based upon a detection result of the pattern detecting subunit, and output the corrected pixel signal to a display apparatus.

Here, the signal processing device is characterized in that the correction unit includes: a field memory for storing an image signal corresponding to one field; a line memory for storing image signals corresponding to a plurality of lines; a pattern detecting subunit operable to detect a predetermined image pattern that has an influence on writing, by reading the image signals corresponding to the plurality of lines from the line memory and comparing the image signals; a motion detecting subunit operable to read the image signal from the field memory, and detect a part including an image motion using a one-field delay signal and a presently inputted image signal; and a conversion subunit operable to correct a pixel signal based upon detection results of the pattern detecting subunit and the motion detecting subunit, and output the corrected pixel signal to a display apparatus.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the drawings:

FIG. 1 is a flowchart of the processing executed by a signal processing device for use in an image display apparatus relating to a first embodiment of the present invention;

FIG. 2 is a block diagram showing the construction of the signal processing device for use in the image display apparatus relating to the first embodiment;

FIG. 3 is a diagram for explaining the operation of a pattern detecting unit in the first embodiment;

FIG. 4 is a diagram for explaining the operation of a judgment unit in the first embodiment;

FIGS. 5A and 5B are diagrams for explaining the function of a conversion table in the first embodiment;

FIG. 6 is an example pattern with a high probability of erroneous writing operation;

FIG. 7 is an example of display pattern correction of a still image part in the first embodiment;

FIG. 8 is an example of display pattern correction of a moving image part in the first embodiment;

FIG. 9 shows an example of a still image pattern;

FIG. 10 shows an example of a moving image pattern;

FIG. 11 shows a correction area of a still image;

FIG. 12 shows a correction area of a moving image;

FIG. 13 shows an example of an image display pattern in a second embodiment of the present invention;

FIG. 14 shows an example of an image display pattern in a third embodiment of the present invention;

FIG. 15 shows an example pattern with a high probability of erroneous writing operation;

FIG. 16 shows an example of an image display pattern in a fourth embodiment of the present invention;

FIG. 17 shows an example of an image display pattern in the fourth embodiment; and

FIG. 18 is a block diagram showing the construction of a signal processing device for use in an image display apparatus relating to a fifth embodiment of the present invention.

### BEST MODE FOR CARRYING OUT THE INVENTION

### First Embodiment

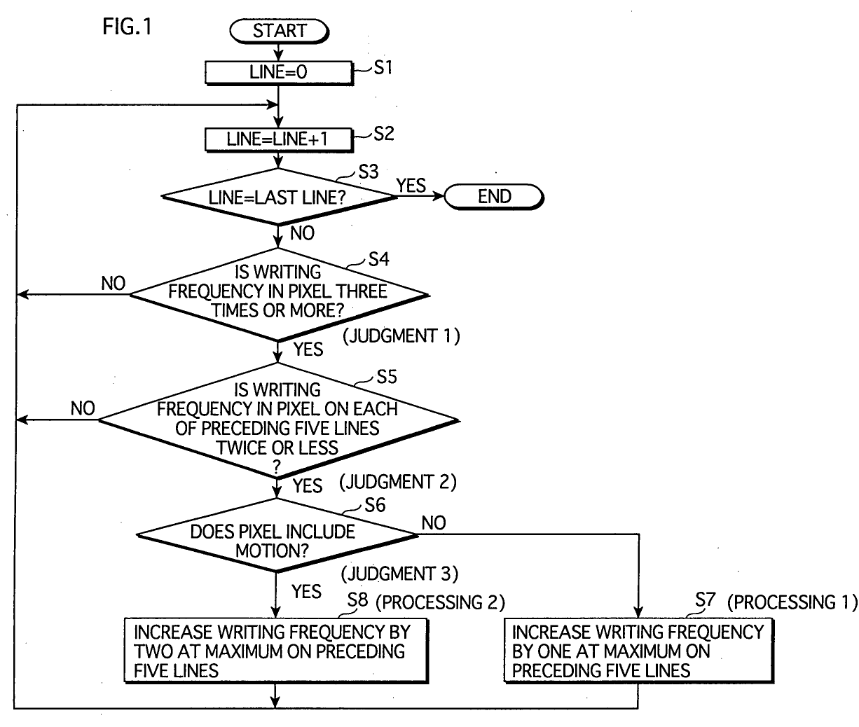

FIG. 1 shows an example flowchart of the processing executed by a signal processing device for use in an image display apparatus relating to a first embodiment of the present invention. The following describes the processing flow, with reference to FIG. 1. A PDP apparatus is preferably used as the image display apparatus relating to the first embodiment. The PDP apparatus includes a display panel that is made up of a front plate and a back plate placed as opposed to each other with barrier ribs interposed between them, where pixels on each horizontal line are separated from one another by the barrier ribs, and pixels on each vertical line are spatially connected with one another. On the display panel of this PDP apparatus, display information is written into each pixel on the same horizontal line, i.e., the writing operation enables scanning to be performed in units of horizontal lines, so that display information is written into all pixels.

Display signals are corrected in units of lines. The correction process is started from a line to be scanned first (Line=0, i.e., the first line (i=1)) (S1). It should be noted here that the correction process may not necessarily be performed from top to down on the screen, but is to be performed in the scanning order employed for the writing operation of display information. For example, when the writing of display information is performed by interlaced scanning, the correction process including judgment of preceding lines and detection of a line to be corrected is performed in the order determined according to that scanning order.

When the frequency of writing in a pixel (target pixel) with luminance of at least a predetermined value is three times or more (Judgment 1: S4) and the frequency of writing in a pixel corresponding to the target pixel on each of five lines preceding the present line including the target pixel is twice or less (Judgment 2: S5), in other words, when the corresponding pixel on each of at least five adjacent lines preceding the present line including the target pixel requires a lower frequency of writing than the target pixel, these corresponding pixels on the preceding five lines are determined to be subjected to signal correction. According to this flowchart, the processing from steps S2 to S5 is repeatedly performed on each of the first five lines (i.e., until i=5), and as a result, these five lines are determined not to be subjected to signal correction. However, these five lines may be separately subjected to signal correction. Here, “i” may be any value that is an integer equal to or greater than two, because there should be at least one line preceding the present line.

For each pixel determined to be subjected to signal correction, the judgment is performed as to whether the pixel includes a motion of an image, by comparing the pixel with a corresponding pixel of the previous field (Judgment 3: S6) When the pixel is judged not to include any motion, the pixel is subjected to such correction as to increase the frequency of writing by one at the maximum (Processing 1: S7). When the pixel is judged to include a motion, the pixel is subjected to such correction as to increase the frequency of writing by two at the maximum (Processing 2: S8). Upon correction of all the pixels on the lines determined above to be subjected to signal correction, the correction process ends.

An image signal including image data corrected in the above-described way is divided into a plurality pieces of display information corresponding in one-to-one to a plurality of subfields. As a result, an image matching the image signal is displayed on the display panel of the PDP apparatus with the intra-field time division gray-scale display method.

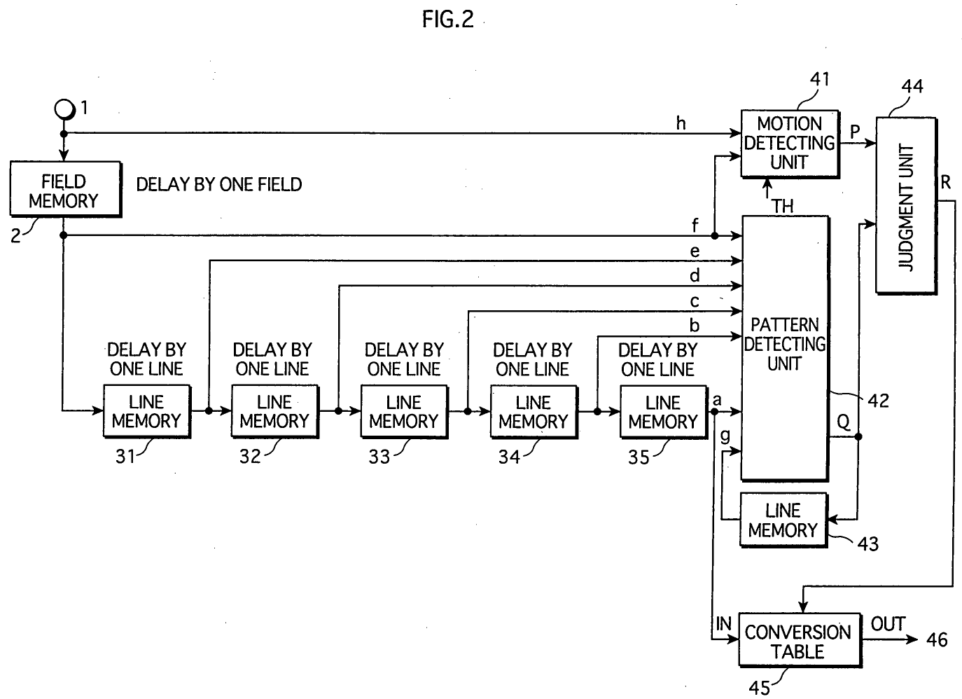

FIG. 2 is an example block diagram showing the construction of a signal processing device that is for use in the image display apparatus relating to the first embodiment and that executes the above-described processing. Numeral 1 denotes an input signal, numeral 2 a field memory, numerals 31 to 35 line memories, numeral 41 a motion detecting unit, numeral 42 a pattern detecting unit, numeral 43 a line memory, numeral 44 a judgment unit, numeral 45 a conversion table, and numeral 46 an output signal.

According to the output signal 46, pixels to be displayed are displayed in a gray-scale on a display screen (not shown) of a PDP or the like provided at the lower reach of output from the signal processing device, with the time division gray-scale display method as described above. Assume here that the input signal is a 6-bit digital signal. The input signal corresponding to one field is divided into six pieces of display information respectively corresponding to six subfields, and luminance weights of 1, 2, 4, 8, 16, and 32 are respectively assigned to the six subfields, so as to produce 64 levels of gray-scale. The following gives examples of methods for writing display information into each pixel. One well-known method is for selectively generating write discharge only in pixels to be displayed, so as to accumulate a wall charge therein. Another well-known method is for accumulating in advance a wall charge in all pixels, and selectively causing weak discharge in pixels not to be displayed, so as to eliminate a wall charge therein while maintaining a wall charge in pixels to be displayed (this method is disclosed in Japanese Laid-Open Patent Application No. H7-287549). In the present embodiment, either of these methods may be employed as the writing method, or other methods may also be employed. The following description is based upon a PDP apparatus employing, as one example, the above method for selectively generating write discharge only in pixels to be displayed, so as to accumulate a wall charge therein.

The following describes the operation of the signal processing device used in the image display apparatus with the above-described construction, and also describes the constructions of the components of the signal processing device. It should be noted here that the following operation is performed on data of each of pixels that are inputted and outputted one by one, as in the case of conventional typical circuit constructions.

The input signal 1, for example, is a digital value obtained by subjecting an input analog signal to A/D conversion, and is an image signal corresponding to one field upon which pieces of display information to be written into pixels are based. This signal, being supplied into the field memory 2, is delayed by one field therein, and then is inputted into the first line memory 31, out of the group of line memories 31 to 35. At the same time, this signal is also supplied into the motion detecting unit 41.

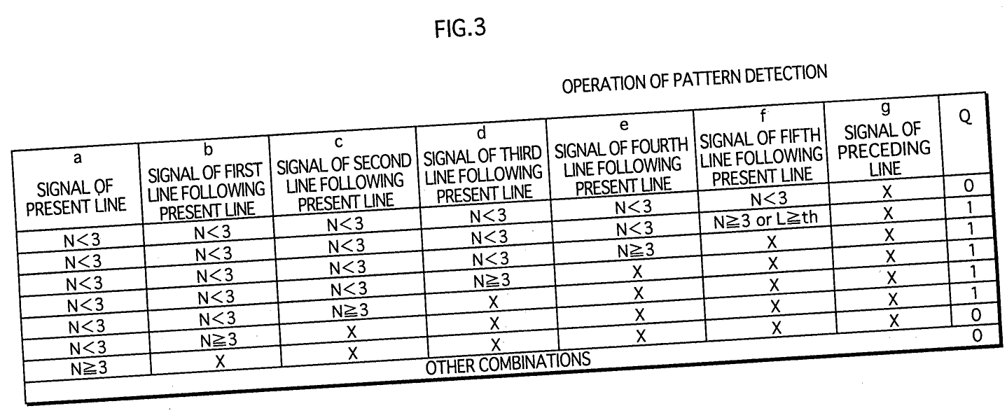

The motion detecting unit 41 detects an image part including a motion, by comparing the inputted signal “h” and the signal “f” obtained by delaying the input signal 1 by one field. Also, the pattern detecting unit 42 detects whether each pixel arranged in the horizontal line direction includes a pattern to be corrected, by using the output (signal “f”) from the field memory 2 and the outputs (signals “a”, “b”, “c”, “d”, and “e”) from the five line memories. The detection of such a pattern to be corrected can be performed by comparing values equivalent to values of the frequency of writing display information described above, using for example a method shown in FIG. 3. FIG. 3 shows one example of control for judging whether pixels on the present line “a” each include a data pattern to be corrected, based upon the state of the five lines immediately following the present line “a”, and the state of the line immediately preceding the present line “a”. It should be noted here that this pattern judgment is performed by comparing each pixel (target pixel) on the present line with pixels that are positionally corresponding to the target pixel on the other lines. This is because pixels arranged in the same vertical line have the largest influence on each other in writing display information.

As shown in FIG. 3, when five lines including the present line each show a low frequency of writing (less than three times), and the fifth line following the present line shows a high luminance (L≧th, where “L” denotes a luminance and “th” denotes a threshold) or shows a high frequency of writing, a correction signal [Q=1] for correcting the present line is outputted. Without the present line being corrected here, erroneous writing is expected to occur on the fifth line following the present line, causing defective light emission. Thereafter, the same correction process needs to be performed on the four lines immediately following the present line, by setting the four lines one after another as a present line. Here, the status of a line immediately preceding the set present line is to be stored in the line memory 43 and to be used for the judgment. By doing so, pixels to be subjected to correction can be detected correctly. On the other hand, when the present line shows a high frequency of writing (three times or more), lines following the present line do not need to be corrected. It is needless to say that a pixel on the present line whose corresponding pixel on the immediately preceding line shows a high frequency of writing does not need to be corrected either.

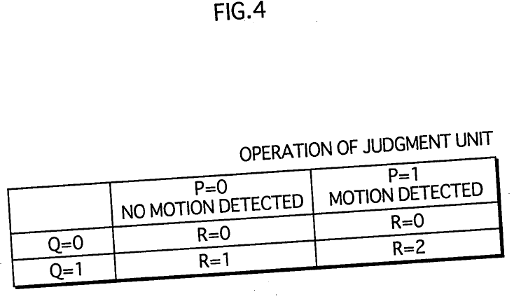

FIG. 4 shows the operation of the judgment unit 44. The judgment unit 44 determines a value of the conversion table controlling signal “R” according to values of “P” and “Q”. To be more specific, the judgment unit 44 selects a value of the conversion table controlling signal “R” for a target pixel as shown in the figure, depending on whether the target pixel includes a motion or not. Here, whether the pixel includes a motion or not can be determined by judging whether an absolute value of a difference in luminance between the target pixel of the input signal “h” and the corresponding pixel of the one-field delay signal “f” exceeds a predetermined value.

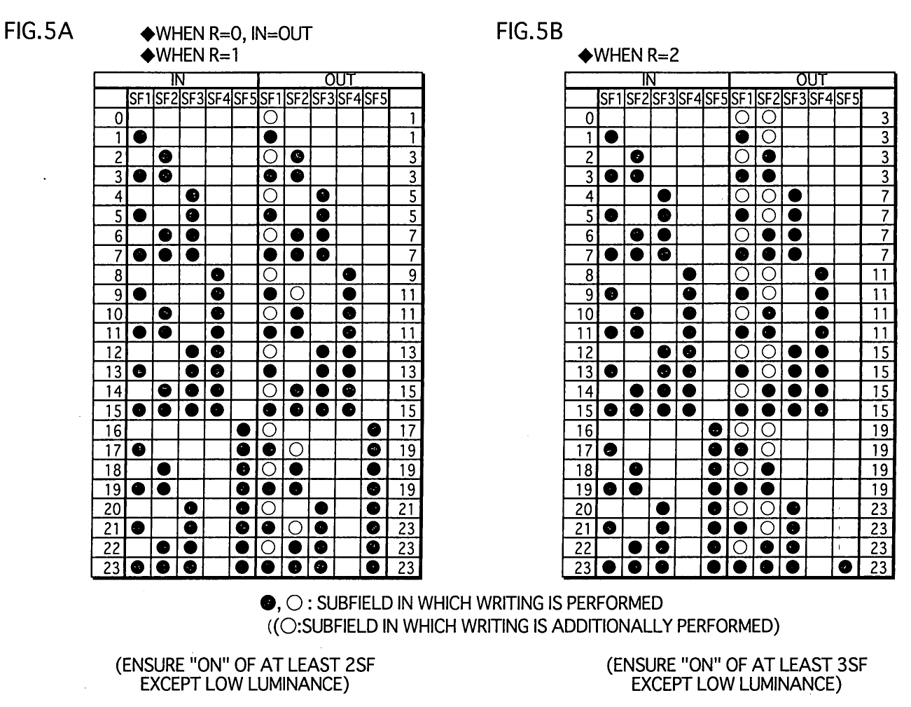

FIGS. 5A and 5B are diagrams for explaining examples of the function of the conversion table 45. The conversion table 45 is used to convert input data according to a value of the conversion table controlling signal“R”. In each figure, the leftmost column shows values of input signals, and the rightmost column shows values of output signals.

When R=0, the conversion operation is not performed. When R=1, such correction as to increase the frequency of writing by one at the maximum is performed as shown in FIG. 5A (a subfield in which writing is additionally performed is indicated by a white circle). When R=2, such correction as to increase the frequency of writing by two at the maximum is performed as shown in FIG. 5B (a subfield in which writing is additionally performed is indicated by a white circle).

In this way, according to the present embodiment, when corresponding pixels arranged in the vertical line direction on lines preceding the target pixel each show a low frequency of writing (assuming a pixel that emits light with a predetermined luminance as a target pixel), a plurality of lines preceding the present line are subjected to such signal correction as to increase the frequency of writing. By doing so, an erroneous writing operation can be prevented. Also, each line to be corrected is subjected to a different range of correction, depending on whether the line includes a motion between fields. Therefore, an erroneous writing operation can be more effectively prevented for such an image where an erroneous writing operation, if occurs, is highly visible, like a moving image in which an object is highly likely to be focused by the eyes of viewers.

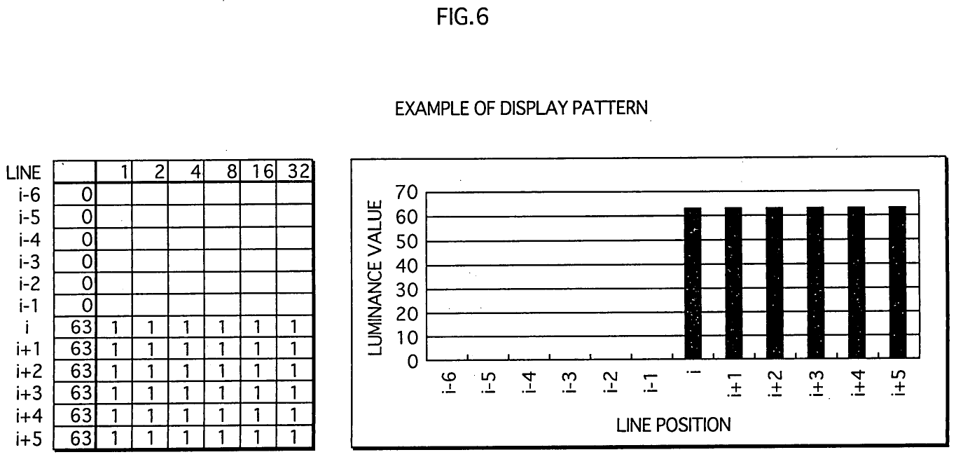

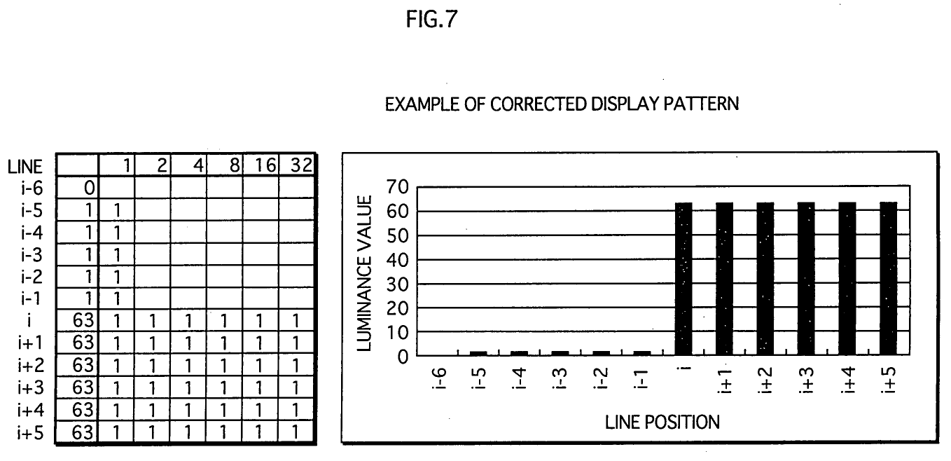

FIG. 6 shows an example of a display pattern for which an erroneous writing operation is highly visible. In the table, the leftmost column shows data values of pixels that are positionally corresponding to one another on different horizontal lines, and the columns besides the leftmost column show values each indicating the light-emitting state of either “ON” or “OFF” (display information) of each subfield. In the graph, luminance values are shown. The same applies to FIGS. 7, 8, 13, 14, 15, 16 ,17, etc referred to later. With the correction operation described above, the display pattern shown in FIG. 6 is converted into the display pattern shown in FIG. 7. To be specific, for the purpose of preventing an erroneous writing operation on the i-th line, the writing operation corresponding to emission of light with a luminance of 1 is intentionally caused for a pattern without light emission on each of the five lines that precede the i-th line having light emission of a luminance of 63. Here, light emission of a luminance of 1 on each of the preceding lines is relatively subtle, as compared with light emission of a luminance of 63 on the i-th line, and therefore, such subtle light emission has only a little influence on the quality of the image displayed.

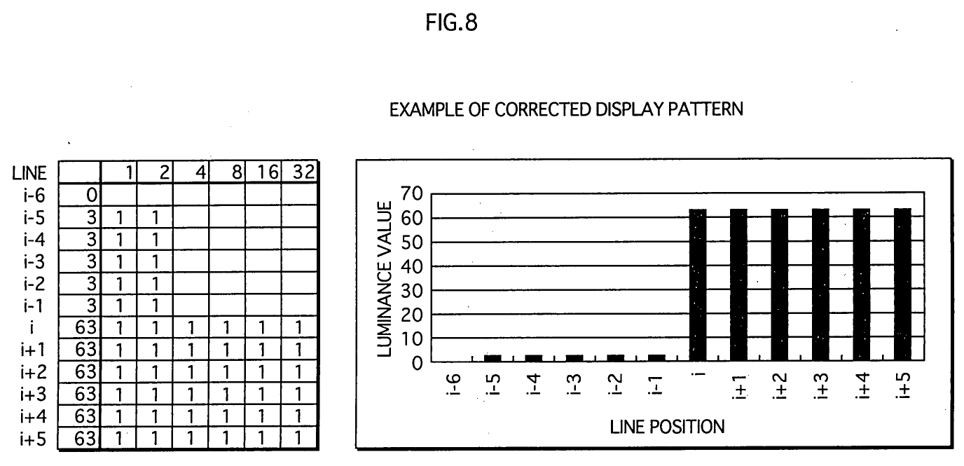

Here, if the signal of the i-th line in the present field shows a high luminance whereas the signal of the i-th line in the previous field shows a luminance of about 0, the probability of an erroneous writing operation occurring is high, and also, an erroneous writing operation, if occurs, is highly visible. This corresponds to the case of a moving part of an image. In this case, the frequency of writing on the preceding line positions is to be increased more as shown in the display pattern in FIG. 8.

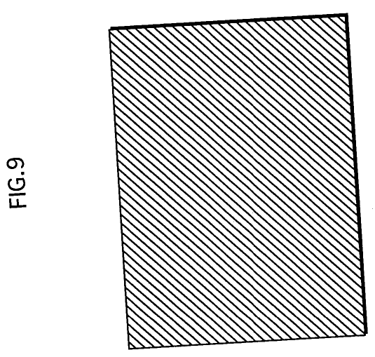

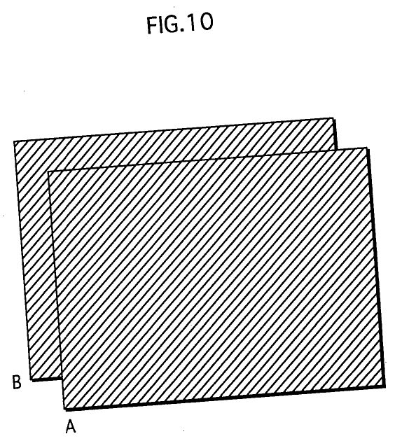

The following again describes the operations of the motion detecting unit 41 and the pattern detecting unit 42 described above, with reference to FIGS. 9 to 12. FIG. 9 shows an example of a still image of a rectangular object whose luminance is higher than that of its background image. FIG. 10 shows an example of a moving image of a rectangular object moving in the diagonal direction from A to B shown in the figure.

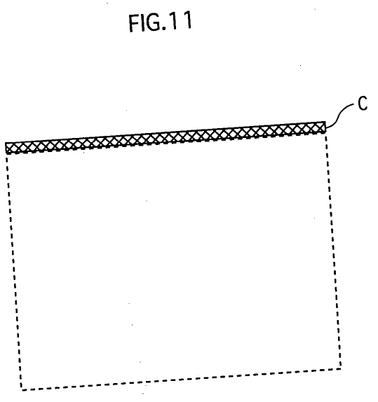

For the still image shown in FIG. 9, an erroneous writing operation is liable to occur at the upper edge part of the rectangular object. This can be considered because pixels in the upper edge part, which is the position where the writing operation is to be started, are not sufficiently activated by previous writing. Therefore, the pattern detecting unit 42 detects a diagonally shaded part shown in FIG. 11 as a part to be subjected to correction. By increasing the frequency of writing in the detected part, an erroneous writing operation can be prevented.

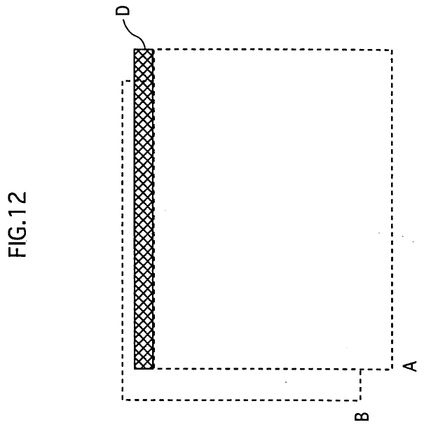

For the moving image where the object is being moved shown in FIG. 10, an erroneous writing operation is liable to occur at the edge part of the object moving in the direction inverse to the scanning direction of the writing operation. This can be considered because pixels in the edge part cannot benefit from the activation by previous writing. The pattern detecting unit 42 and the motion detecting unit 41 detect a diagonally shaded part shown in FIG. 12 as a part to be subjected to correction. It should be noted here that an erroneous writing operation can be more effectively prevented in the diagonally shaded part in FIG. 12 by such correction as to increase the frequency of writing, than in the diagonally shaded part in FIG. 11.

### Second Embodiment

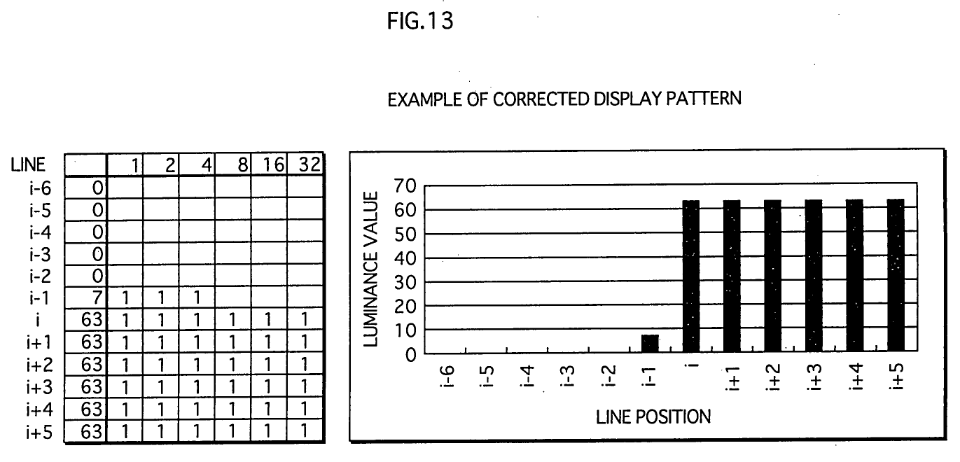

As a second embodiment of the present invention, FIG. 13 shows a case where the number of lines to be subjected to correction is as small as one. In this case, the range of correction is narrow, and accordingly, pixels to be displayed need to meet high requirements. The advantage is, however, that the components such as the pattern detecting unit 42, and the line memories 31 to 35 connected serially can be simplified, and also, changes in signals caused by correction can be kept within a narrow range.

### Third Embodiment

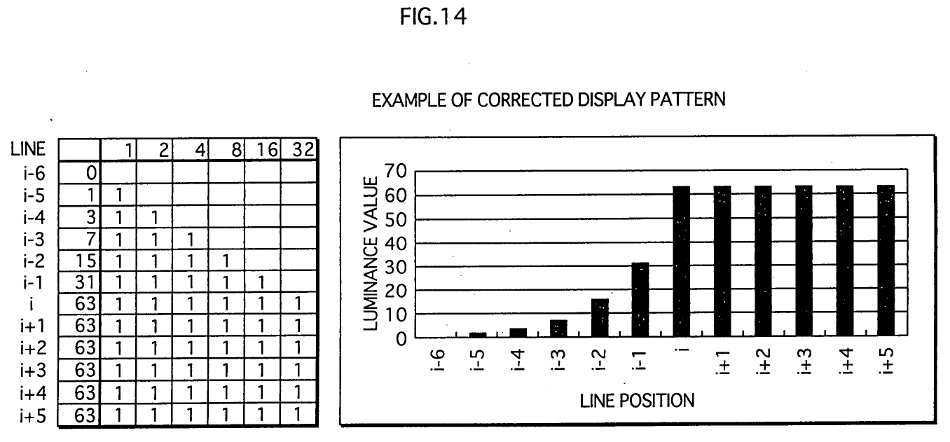

As a third embodiment of the present invention, FIG. 14 shows a case where the degree of correction is made varied continuously for each line. As shown in FIG. 14, the input image signals corresponding to five lines preceding the (i−1) th line are corrected in such a manner that the frequency of writing is 5, 4, 3, 2, and 1 respectively for the five lines.

With this processing, the variation in luminance at an edge part can be reduced, and also, sudden changes in the frequency of writing in the vertical line direction can be reduced, thereby enabling an erroneous writing operation to be sufficiently prevented.

### Fourth Embodiment

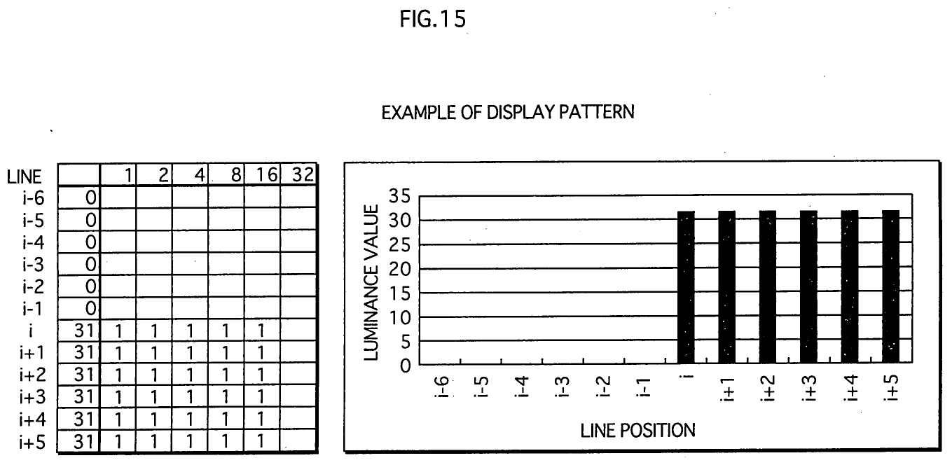

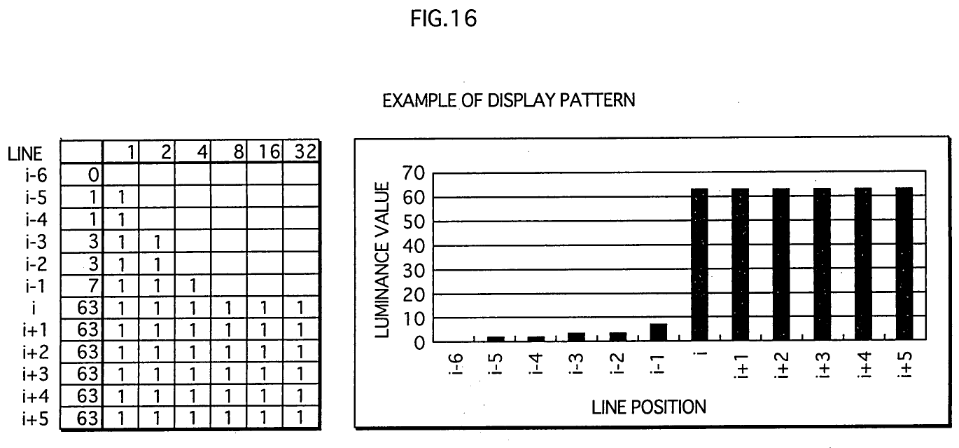

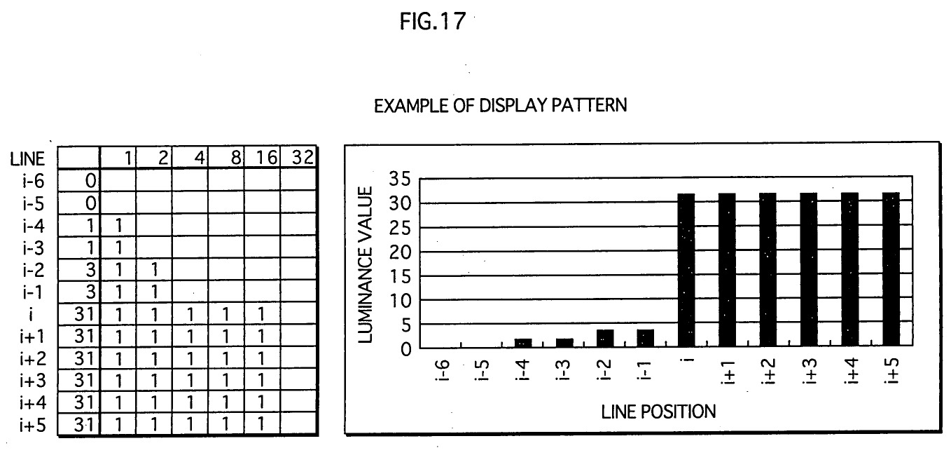

Unlike FIG. 6, FIG. 15 shows a display pattern for emitting light with a luminance of 31, to follow a plurality of lines emitting no light. FIGS. 16 and 17 show the operations to be executed in the fourth embodiment. The display pattern of an image involving a great change in the in-plane luminance shown in FIG. 6 is converted into the display pattern shown in FIG. 16 by way of abroad range of correction (by increasing the frequency of writing in a broad range). The display pattern of an image involving a small change in the in-plane luminance shown in FIG. 15 is converted into the display pattern shown in FIG. 17 by way of a relatively narrow range of correction (by increasing the frequency of writing in a relatively narrow range). In a part where the luminance changes greatly, the frequency of writing generally changes greatly. Accordingly, an erroneous writing operation is liable to occur in such a part, and also, an erroneous writing operation, if occurs, can be highly visible in such a part. Therefore, such a part is to be subjected to a broad range of correction, for the purpose of reducing an erroneous writing operation therein.

### Fifth Embodiment

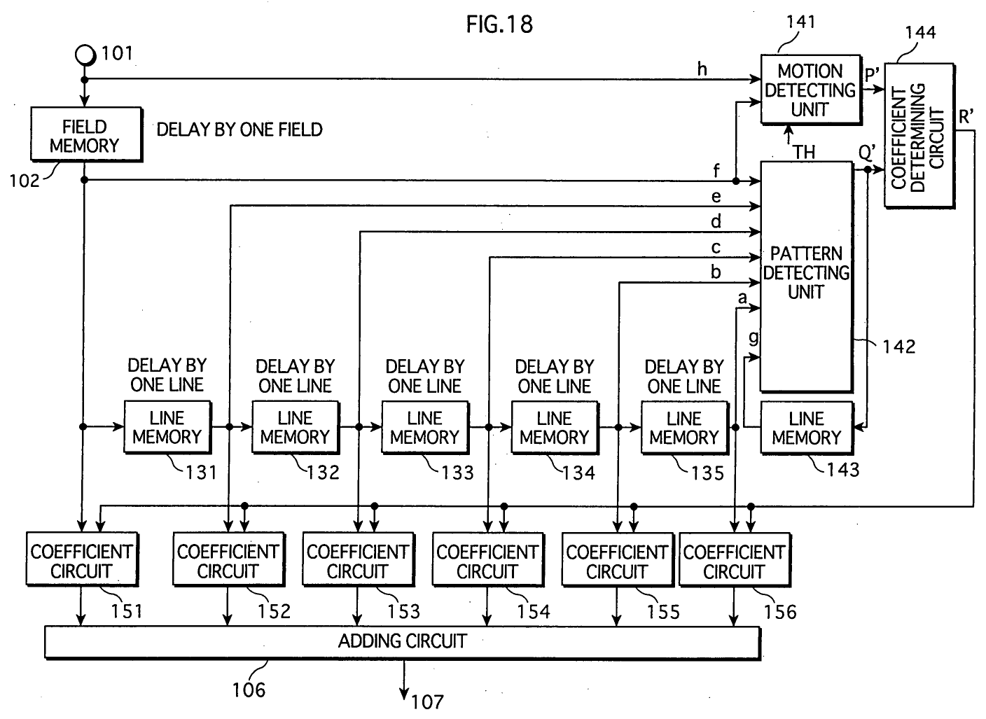

FIG. 18 shows a fifth embodiment of the present invention. Numeral 101 denotes an input signal, numeral 102 a field memory, numerals 131 to 135 line memories, numeral 106 an adding circuit, numeral 141 a motion detecting unit, numeral 142 a pattern detecting circuit, numeral 143 a line memory, numeral 144 a coefficient determining circuit, and numerals 151 to 156 coefficient circuits.

In FIG. 18, detection of a motion (output being “P′”) and detection of a pattern (output being “Q′”) are performed using the signal“a” of the present line and the signals “b” to “f” of the preceding lines, and the signal “h” of the corresponding line in the previous field, in the same manner as that described in the first embodiment.

According to this construction, patterns of the signals “b” to “f” of the lines preceding the signal “a” of the present line and the signal “h” of the corresponding line in the previous field are detected. According to the detected patterns of the signals “a” to “h”, weights are assigned to the signals “a” to “h” of the input signal 101, and the resulting values are summed up, so that the correction operation that is the same as the correction operation described in the first to fourth embodiments can be performed. Also, as in the fist embodiment, the line memory 143 stores the state of the line immediately preceding the present line, to enable the correction operation to be performed correctly and continuously.

It should be noted here that the components given the same names as the components in the first to fourth embodiments perform the same processing as those components. Here, the coefficient determining circuit 144, corresponding to the judgment unit 44 in the first to fourth embodiments, determines and outputs a control signal for controlling the operations of the coefficient circuits 151 to 156 in accordance with an image pattern. The output “R′” from the coefficient determining circuit 144 is a signal with a plurality of bits, which can control each of the coefficient circuits 151 to 156 independently. The coefficient circuits 151 to 156 perform the processing corresponding to the conversion table by way of computing using coefficients.

With the construction shown in FIG. 18, the line memories 131 to 135, the coefficient circuits 151 to 156, and the adding circuit 106 constitute a so-called “FIR filter” for assigning a weight to each line and summing up the resulting values. With the construction of the present embodiment, therefore, the signal processing for controlling an erroneous operation according to the present invention and the signal processing including contour correction can be performed in parallel.

### Modification Examples

Although the above embodiments describe the case where the range of correction for a moving image extends as narrow as to the range of five lines, the present invention is not limited to such. The present invention can be applied to a case where the range of correction extends to a range of more or less lines. Also, patterns for which erroneous writing is liable to occur are not limited to the patterns specifically described in the above embodiments, and such patterns may of course be various patterns described in the claims.

Also, although the above embodiments describe the case where the method for selectively generating write discharge in pixels to be displayed to accumulate a wall charge therein is employed as the method for writing display information into pixels, the present invention should not be limited to such. The present invention can also be applied to a case where the method is employed for accumulating in advance a wall charge in all pixels and selectively causing weak discharge in pixels not to be displayed, so as to eliminate a wall charge therein while maintaining a wall charge in pixels to be displayed. In this case, the signal processing to be performed is the same as that described in the above embodiments. However, the erasing frequency for lines preceding, in terms of a writing order, the present line is to be increased in correspondence with such correction to increase the frequency of writing. With this processing, activation of the present line can be facilitated, thereby preventing erroneous erasing on the present line.

When the above method of using erasing discharge is employed as the writing method, erroneous writing is particularly liable to occur to such a pattern obtained by turning the pattern in FIG. 6 upside down. With the pixel data having the maximum value of 63, the frequency of erasing is 0, whereas with the pixel data having the minimum value of 0, the frequency of erasing is 6, which is the maximum. Therefore, a pixel corresponding to the pixel data having the minimum value of 0 is less liable to be activated because this pixel cannot benefit from the activation of the preceding line.

In view of this, by correcting pixel data on the preceding line so as to decrease the display luminance, the frequency of erasing can be increased. Therefore, the pixels on the preceding line can be activated one after another, so that the pixels on the present line whose pixel data have the minimum value of 0 can be activated. Further, when this writing method is employed in the above embodiments, the same control over the frequency of erasing as described here can be performed.

To be more specific, for a still image, image signals of five lines preceding the i-th line are corrected to increase the frequency of erasing by one, as to pixels arranged in the same vertical line as the present pixel. For a moving image, image signals of five lines preceding the i-th line are corrected to increase the frequency of erasing by two, as to pixels arranged in the same vertical line as the present pixel.

When this writing method is employed in the second embodiment, the image signals are corrected so that the frequency of erasing is increased only by one line ((i−1)th line).

When this writing method is employed in the third embodiment, the image signals are corrected so that the frequency of erasing is increased by five, four, three, two, and one line respectively for the five lines preceding the (i−1)th line.

When this writing method is employed in the fourth embodiment, the range of correction of a display pattern is expanded (the frequency of erasing is increased in a broad range) for a part of an image including a great change in the in-plane luminance, and the range of correction of a display pattern is narrowed (the frequency of erasing is increased in a narrow range) for a part of an image including a relatively small change in the in-plane luminance.

According to the above-described embodiments, such a part for which erroneous writing of display information is highly visible is detected, and the frequency of writing display information is increased in the detected part. By doing so, pixels can be activated, thereby improving the accuracy of writing information in the pixels. Also, by increasing the degree of activation of pixels, the accuracy of writing information can be enhanced.

Also, by increasing the frequency of light emission in a subfield to which a small luminance weight is assigned, an influence on the display quality in a part with a relatively low luminance can be reduced. Therefore, the frequency of writing display information in a part where erroneous writing is liable to occur can be increased, thereby effectively reducing the probability of erroneous writing while reducing side effects including contrast deterioration.

Also, among areas with a probability of erroneous writing, particularly a moving image part where erroneous writing is more liable to occur is subjected to a broad range of correction of writing information. Therefore, an image display with reduced erroneous writing is enabled by sufficient correction of a moving image without any side effects, and also an image display with reduced erroneous writing is enabled by suitable correction of a still image.

Also, writing information is corrected according to the scanning, i.e., the writing of display information. Therefore, an image display with effectively reduced erroneous writing is enabled.

Also, a part where erroneous writing is liable to occur or apart where erroneous writing, if occurs, is highly visible, is detected in advance and a signal corresponding to the detected part is subjected to correction. Due to this, the probability of erroneous writing can be effectively reduced while side effects are being prevented. In particular, by the judgment about the direction in which display information is written and the judgment about motions of images, corrected display information of a present line is written before display information of a line following the present line is written. This ensures correct writing of the display information on the following line. Accordingly, a pixel can be effectively activated, and correct writing of display information can be ensured without such side effects that may cause a great change in the image quality.

It should be noted here that the present invention is not limited to the embodiments described above, and any other modifications that produce the same effects as in the above embodiments are of course fallen within the technical concepts of the present invention.

For example, a luminance weight of each subfield, and the frequency of writing and the threshold used in the judgments are not limited to those described in the above embodiments, but various modifications of these can produce the same effects as described in the above embodiments.

### Industrial Application

The signal processing device of the present invention features a stable operation of writing display information in such display apparatuses as PDPs, and therefore exhibits extremely high utility values in that the device enables display of high-quality images.

1. A signal processing device that enables a display apparatus to perform image display using a plurality of subfields into which one field is divided, by writing display information of one subfield into pixels on each scan line of the display apparatus based upon an image signal of one field, the signal processing device characterized by including
a correction unit operable to correct an image signal corresponding to display information to be written into a j-th pixel on at least one scan line preceding, in terms of a writing order, an i-th scan line within one field, based upon a pattern of display information to be written into a j-th pixel on the i-th scan line and a pattern of display information to be written into a j-th pixel on a scan line preceding the i-th scan line.

2. A signal processing device that enables a display apparatus to perform image display using a plurality of subfields into which one field is divided, by writing display information of one subfield into pixels on each scan line of the display apparatus based upon an image signal of one field, the signal processing device characterized by including
a correction unit operable to correct an image signal corresponding to display information to be written into a j-th pixel on at least one scan line preceding, in terms of a writing order, an i-th scan line within one field, based upon a pattern of display information to be written into a j-th pixel on an i-th scan line over a plurality of fields.

3. The signal processing device of one of claims 1 and 2, characterized in that
the display information is information for lighting each pixel, and
the correction unit is operable to correct the image signal so as to increase a frequency of writing display information into the j-th display pixel on at least one scan line preceding, in terms of a writing order, the i-th scan line.

4. The signal processing device of one of claims 1 and 2, characterized in that
the display information is information for erasing each pixel, and
the correction unit is operable to correct the image signal so as to increase a frequency of writing display information into the j-th display pixel on at least one scan line preceding, in terms of a writing order, the i-th scan line.

5. The signal processing device of claim 3, characterized in that
the correction unit is operable to correct the image signal so as to increase a frequency of writing display information into a pixel (a) by a smaller degree as a scan line of the pixel precedes more, in terms of a writing order, the i-th scan line, or (b) by a substantially same degree as a scan line preceding, in terms of a writing order, the i-th scan line.

6. The signal processing device of claim 4, characterized in that
the correction unit is operable to correct the image signal so as to increase a frequency of writing display information into a pixel (a) by a smaller degree as a scan line of the pixel precedes more, in terms of a writing order, the i-th scan line, or (b) by a substantially same degree as a scan line preceding, in terms of a writing order, the i-th scan line.

7. The signal processing device of claim 2, characterized in that
the correction unit is operable to correct the image signal when an image to be displayed for the j-th pixel on the i-th scan line corresponds to an edge part of a moving image.

8. The signal processing device of claim 7, characterized in that
the edge part of the moving image is a part moving in a direction inverse to a direction in which writing of display information is performed in each subfield.

9. The signal processing device of one of claims 1 and 2, characterized in that
the correction unit is operable to correct the image signal in such a manner that an amount of light emission on a line preceding, in terms of a correction order, the i-th scan line is half or less of an amount of light emission on the i-th scan line.

10. The signal processing device of one of claims 1 and 2, characterized in that
the correction unit is operable to increase a frequency of writing display information in a subfield selected from a plurality of subfields, according to priority of a smaller luminance assigned thereto.

11. The signal processing device of one of claims 1 and 2, characterized in that
the correction unit is operable to perform a broader range of correction in a part where an image to be displayed therein has a large variety of luminance, than in a part where an image to be displayed therein has a small variety of luminance.

12. The signal processing device of claim 1, characterized in that
the correction unit includes:
a line memory for storing image signals corresponding to a plurality of lines;
a pattern detecting subunit operable to detect a predetermined image pattern that has an influence on writing, by reading the image signals corresponding to the plurality of lines from the line memory and comparing the image signals; and
a conversion subunit operable to correct a pixel signal based upon a detection result of the pattern detecting subunit, and output the corrected pixel signal to a display apparatus.

13. The signal processing device of claim 2, characterized in that
the correction unit includes:
a field memory for storing an image signal corresponding to one field;
a line memory for storing image signals corresponding to a plurality of lines;
a pattern detecting subunit operable to detect a predetermined image pattern that has an influence on writing, by reading the image signals corresponding to the plurality of lines from the line memory and comparing the image signals;
a motion detecting subunit operable to read the image signal from the field memory, and detect a part including an image motion using a one-field delay signal and a presently inputted image signal; and
a conversion subunit operable to correct a pixel signal based upon detection results of the pattern detecting subunit and the motion detecting subunit, and output the corrected pixel signal to a display apparatus.
